(19) United States
(12) Patent Application Publication
(10) Pub. No.: US 2011/0216355 A1
(43) Pub. Date: Sep. 8, 2011

(54) COMPUTER READABLE RECORDING MEDIUM RECORDING PRINTER DRIVER, PRINT CONTROL DEVICE, AND COMPUTER READABLE RECORDING MEDIUM RECORDING PRINTER SEARCH PROGRAM

(75) Inventors: Noriyuki TAKEI, Shiojiri-shi (JP); Shuji WAKUMOTO, Matsumoto-shi (JP); Satoru NAKAYAMA, Shiojiri-shi (JP)

(73) Assignee: SEIKO EPSON CORPORATION, Tokyo (JP)

(21) Appl. No.: 13/025,309

(22) Filed: Feb. 11, 2011

(30) Foreign Application Priority Data
Mar. 8, 2010 (JP) 2010-050575

(51) Int. Cl. G06F 15/00

(52) U.S. Cl. 358/1.15

(57) ABSTRACT

A computer readable recording medium recording a printer driver in which the printer driver makes a computer function as a device including a search unit which searches for printers that can be used for printing and a printer information storage unit which stores predetermined information relating to at least some of the printers out of the searched printers, in which the search unit executes searches having the printers of which the predetermined information is stored as a search range.

The entire disclosure of Japanese Patent Application No. 2010-050575, filed Mar. 8, 2010 is expressly incorporated by reference herein.

### BACKGROUND

1. Technical Field

The present invention relates to the technology of searching for printing devices including printers, copy machines, multifunction peripherals, and the like.

2. Related Art

There is known a printer driver (which is referred to as a “common driver”, for example) that searches for a plurality of models of printer (for example, printers that support a specific page description language), and causes a printer that is selected from search results to execute printing. If such a printer driver is installed in a terminal, for example, a mobile PC or the like, it is easy to find a printer to execute printing even if the terminal is moved.

JP-A-2006-195765, for example, discloses a technology in which a terminal sends a printer search request to a server, the server searches for printers close to the current location of the terminal and sends to the terminal a list of printers.

Incidentally, in operating systems (OS) and printer drivers equipped with a printer search function, printers that the terminal can find are unconditionally searched for, and the printers found are listed in order.

However, in such a search method, a user of the terminal needs to wait until all printers that can be found are listed. For example, as the number of printers present on a LAN to which the terminal is connected increases, the waiting time for the user is lengthened.

### SUMMARY

Thus, an advantage of some aspects of the invention is that it improves the efficiency of searching for printers and the convenience of users.

According to a first aspect of the invention, there is provided a printer driver that makes a computer function as a print control device searching for printers, and including a search unit which searches for printers that can be used for printing and a printer information storage unit which stores predetermined information relating to at least some of the printers out of the searched printers, in which the search unit executes searches having the printers of which the predetermined information is stored as a search range.

In the printer driver described above, it is preferable that the printer driver makes the computer function as a first reception unit which displays a list of the searched printers and receives selection of at least some of the printers from the list, and the printer information storage unit stores the predetermined information of the selected printers.

Furthermore, in the printer driver described above, it is preferable that the first reception unit receives selection of the history list on which the selected printers are recorded, and the printer information storage unit can store a plurality of history lists and stores the predetermined information of the selected printers on the selected history list, and the printer driver makes the computer function as a second reception unit which receives selection of a history list which is a search range, and the search unit executes searches having the history list selected by the second reception unit as a search range.

Furthermore, in the printer driver described above, it is preferable that the first reception unit receives identification information of the history lists, the printer information storage unit stores the plurality of the history lists in association with the identification information, and the second reception unit receives selection of a history list based on the identification information.

Furthermore, in the printer driver described above, it is preferable that the first reception unit receives input of rank order information of the printers recorded on the history list, and the printer information storage unit may store the predetermined information of the selected printers in association with the rank order information.

Furthermore, in the printer driver described above, it is preferable that the search unit determines the printer which was found at first according to the ranking information as a printer which can be used for printing having the selected history list as a search range.

Furthermore, in any one of the printer drivers described above, it is preferable that the printer driver makes the computer function as a third reception unit that receives designation of printer functions, the predetermined information includes the printer functions, and the search unit executes search having printers with the designated functions as a search range.

According to another aspect of the invention, there is provided a print control device which searches for printers, including a search unit which searches for printers which can be used for printing, and a printer information storage unit which stores predetermined information relating to at least some of the printers out of the searched printers, in which the search unit executes searches having the printers of which the predetermined information is stored as a search range.

According to still another aspect of the invention, there is provided a printer search program which makes a computer function as a device that searches for printers and includes a search unit which searches for printers that can be used for printing and a printer information storage unit which stores predetermined information relating to at least some of the printers out of the searched printers, in which the search unit executes searches having the printers of which the predetermined information is stored as a search range.

### BRIEF DESCRIPTION OF THE DRAWINGS

The invention will be described with reference to the accompanying drawings, wherein like numbers reference like elements.

FIG. 1 is a diagram illustrating the schematic composition of hardware of a printing system which is an example of an embodiment of the invention.

FIG. 2 is a block diagram illustrating an example of the functional composition of a host computer.

FIG. 3 is a diagram illustrating an example of a printer selection screen which receives selection of a printer.

FIG. 4 is a diagram illustrating an example of a search condition setting screen which receives setting for search conditions.

FIG. 5 is a diagram illustrating an example of a search result storing screen which stores search results.

FIG. 6 is a diagram illustrating an example of a search result reading screen which reads the search results.

FIG. 7 is a flowchart illustrating an example of a printer selecting process.

### DESCRIPTION OF EXEMPLARY EMBODIMENTS

Hereinafter, an embodiment of the invention will be described with respect to drawings.

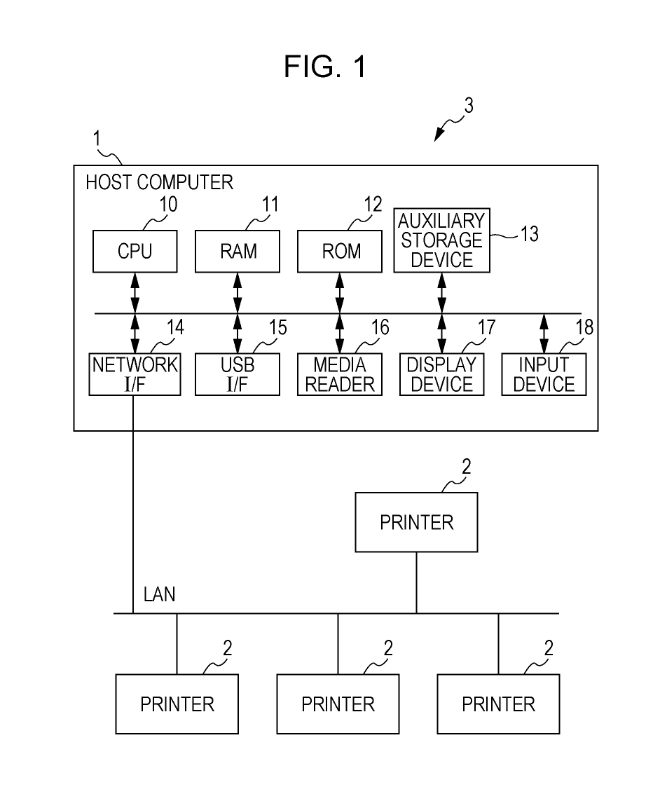

FIG. 1 is a diagram illustrating the schematic composition of the hardware of a printing system 3 which is an example of the embodiment of the invention.

The printing system 3 includes a host computer 1 which functions as a print control device, and a plurality of printers 2 which function as printing devices. The host computer 1 and the printers 2 communicate with each other through a network, for example, a wired LAN and the like.

The host computer 1 is installed with a printer driver to be described below which has the function of searching for printers available on a network, and controls printing by one of the selected printers 2. The printer 2 carries out printing based on print data which are sent from the host computer 1 in the form of PDL or the like.

The host computer 1 is provided with, for example, a CPU 10 which carries out a variety of arithmetic operations, a RAM 11 which accommodates data and programs executed by the CPU 10 and the like, a ROM 12 which accommodates data and programs necessary for activation and the like in advance, an auxiliary storage device 13 including a hard disk drive (HDD), a solid state drive (SDD), or the like, a network interface (I/F) 14 which carries out communication by being connected to a network such as a wired LAN or the like, a USB interface (I/F) 15 which carries out communication through a USB, a media reader 16 which reads information in a portable storage medium having portability such as CD-ROM or the like, a display device 17 including an LCD or the like which displays a user interface (UI) screen or the like, and an input device 18 including a keyboard, a mouse or the like.

The printer 2 has, for example, a laser type or ink jet type printing mechanism, and carries out color or monochrome printing. Of course, the printing type is not limited to the above.

Although the major composition of the printing system 3, the host computer 1, and the printer 2 is described for illustrating characteristics of this invention, the composition is not limited thereto. In addition, the composition of general printing systems, host computers, and printers is not excluded. For example, there may be a plurality of the host computers 1, and the number of the printers 2 may be one. Moreover, the host computer 1 and the printer 2 may communicate with each other through, for example, a wireless LAN.

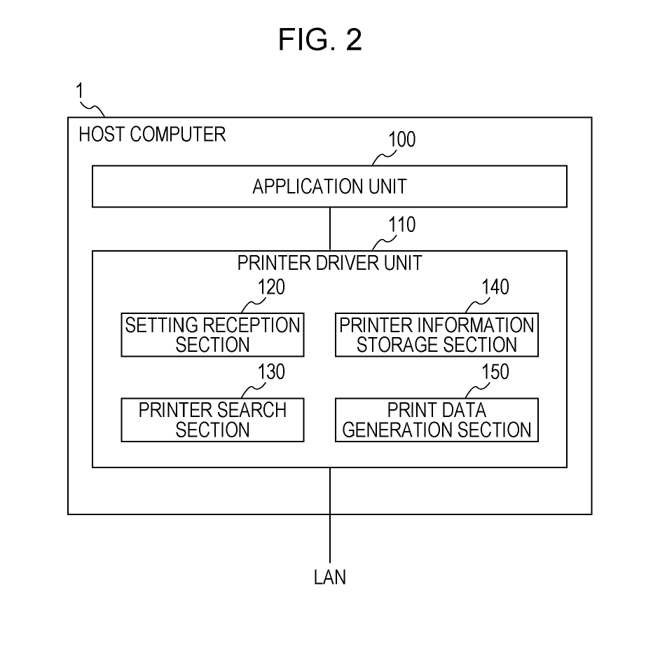

FIG. 2 is a block diagram illustrating an example of the functional composition of the host computer 1.

The host computer 1 includes an operating system (OS) unit (not shown in the drawing), an application unit 100, and a printer driver unit 110.

The OS unit and the application unit 100 are realized, for example, by executing a predetermined OS program and a predetermined application program that the CPU 10 loads in the RAM 11 from the auxiliary storage device 13. The printer driver unit 110 is realized, for example, by executing a predetermined printer driver program that the CPU 10 loads in the RAM 11 from the auxiliary storage device 13.

Furthermore, the printer driver program can be downloaded, for example, from a server on a network such as the Internet, or the like, and installed or updated on the host computer 1. The printer driver program may be read from a storage medium including a CD-ROM or the like by the media reader 16 or from a storage medium including a flash ROM or the like through the USB interface 15, and installed or updated in the host computer 1.

The OS unit has a function of managing the system of the host computer 1 and providing a basic user operation environment, which is a so-called basic software function. The application unit 100 and the printer driver unit 110 are realized under the management of the OS unit.

The application unit 100 has a function of providing users with specific functions for various purposes, which is so-called an application software function. In this embodiment, the application unit 100 carries out, for example, processing such as creation, display, editing of documents and image files, and the like.

Moreover, the application unit 100 receives instructions of printing files (print target data) which are selected by a user via a predetermined UI screen. When the printing instruction is received, the application unit 100 informs the printer driver unit 110 of the print target data and the received print setting, and instructs printing.

The printer driver unit 110 searches for available printers and performs processes for controlling a selected printer 2 to execute printing. The printer driver unit 110 performs, for example, a process of controlling the display of various UI screens of the printer driver, a process of controlling input by a user's operations through the UI screens, a process of generating print data based on print target data received from the application unit, a process of causing the printer 2 to print by transmitting the print data thereto, or the like.

In addition, in this embodiment, the printer driver unit 110 can respond to a plurality of the printers 2, and performs a process of searching for the printers 2 that can be used by the host computer 1, a process of receiving selection of one of the printers 2 to execute printing.

The printer driver unit 110 includes a setting reception section 120, a printer search section 130, a printer information storage section 140, and a print data generation section 150 in order to implement the processes described above.

Furthermore, in this embodiment, important processes such as reception of print setting, printer search, reception of printer selection, generation of print data, or the like are implemented by a printer driver program, but the processes relating to the printer search and selection may be implemented, for example, by a printer search program that can be linked to the printer driver program.

The setting reception section 120 displays a predetermined UI screen on the display device 17, and receives printer selection, instruction of printer search, setting for printer search conditions, setting for storing printer search results, setting for reading the printer search results, print setting, or the like via an input device 18. In addition, the setting reception section 120 receives a printing instruction and sends the print target data and the various print settings to the print data generation section 150.

When the setting reception section 120 receives instruction for print setting or for print execution by a user's operation via, for example, a predetermined UI screen displayed by the OS unit or the application unit 100, the setting reception section 120 receives printer selection by displaying a predetermined UI screen for receiving a search and selection of a printer to execute printing.

Furthermore, the time when the setting reception section 120 receives a variety of print settings by the user's operation by displaying the predetermined UI screen may be, for example, before or after receiving the instruction of print execution. In this embodiment, since the process of receiving the print setting is not an importance function, description thereof will be omitted.

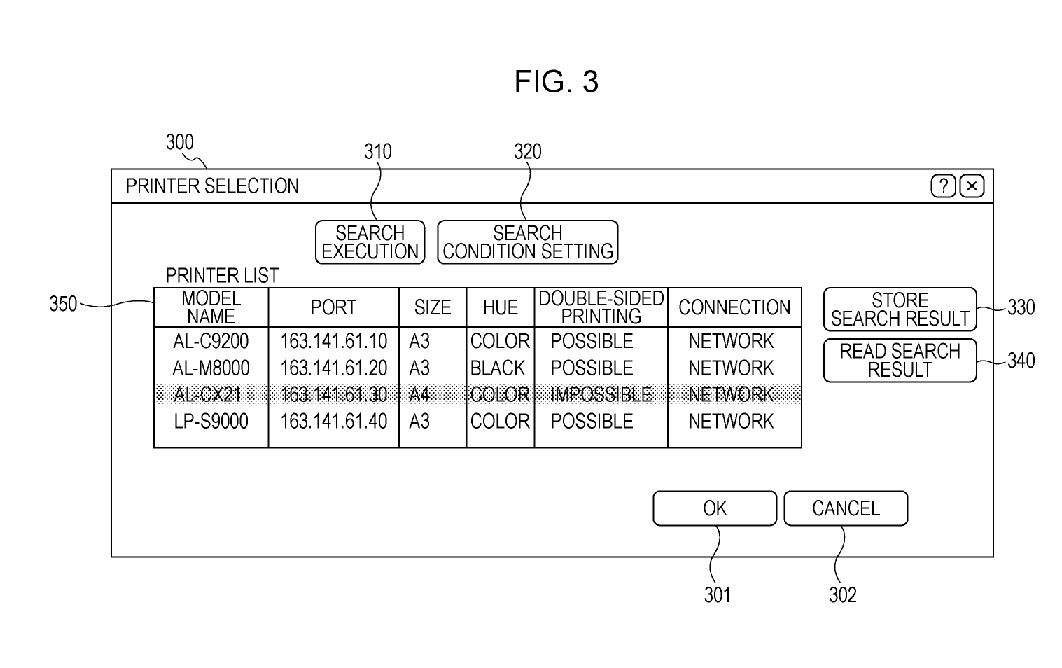

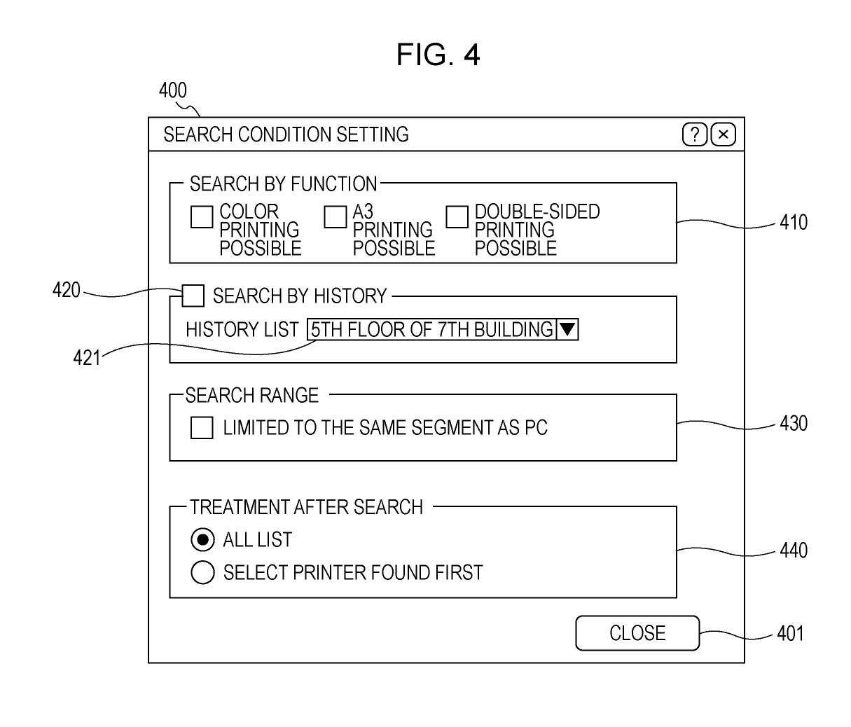

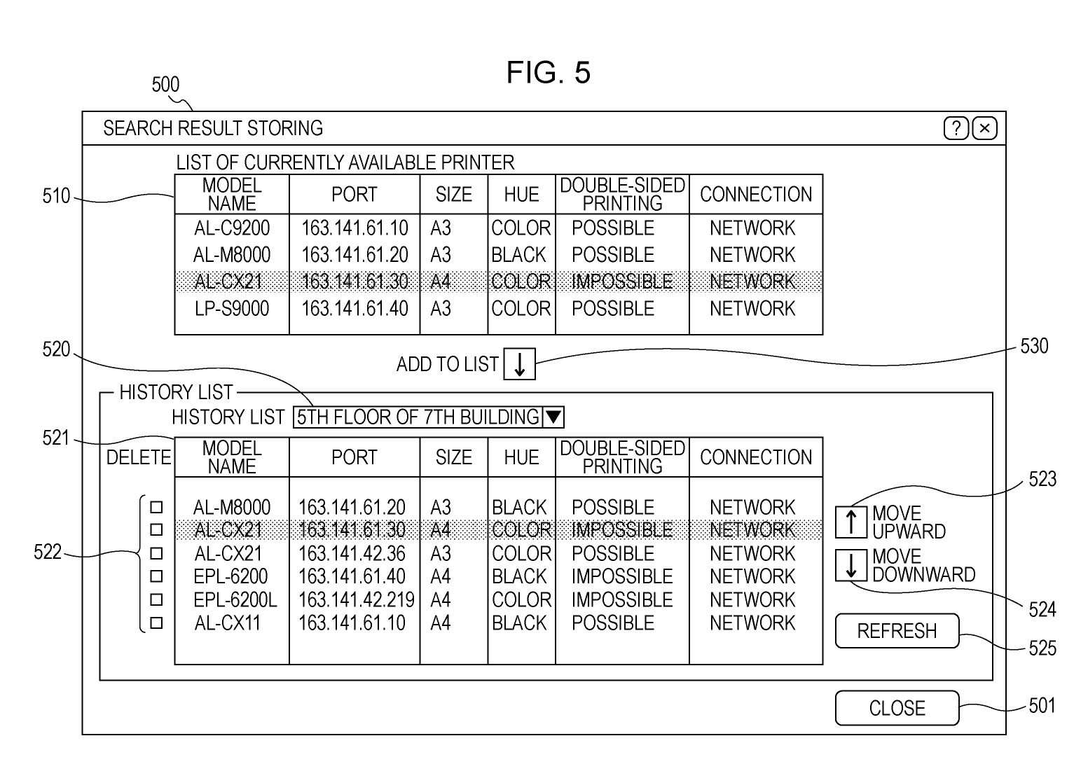

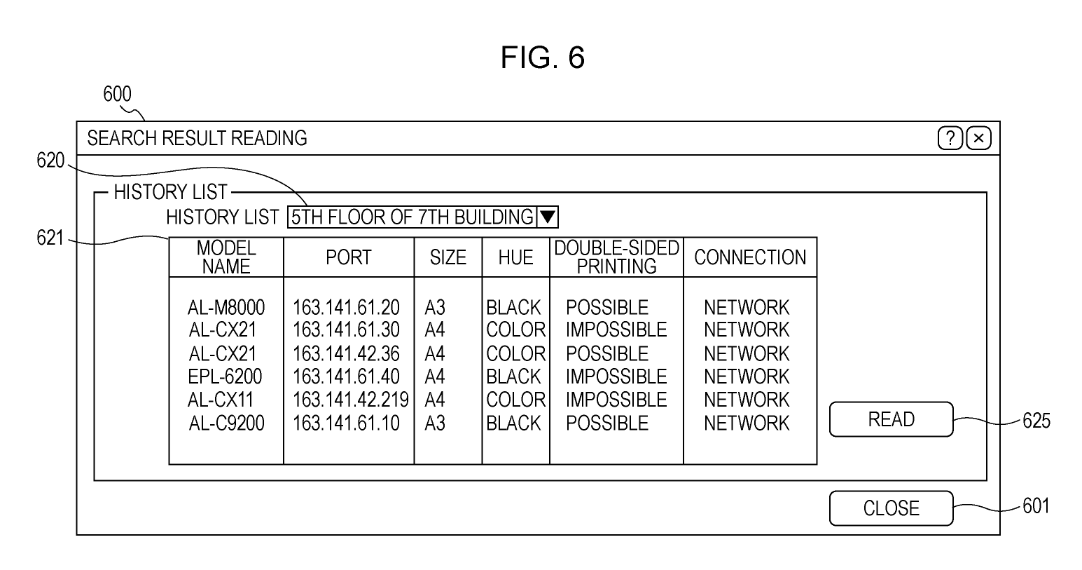

More specifically, the setting reception section 120 displays, for example, the UI screens shown in FIG. 3 to FIG. 6. FIG. 3 is a diagram illustrating an example of a printer selection screen 300 which receives selection of a printer. FIG. 4 is a diagram illustrating an example of a search condition setting screen 400 which receives setting for search conditions. FIG. 5 is a diagram illustrating an example of a search result storing screen 500 which stores search results. FIG. 6 is a diagram illustrating an example of a search result reading screen 600 which reads the search results.

As shown in FIG. 3, the printer selection screen 300 includes a search execution button 310 for executing printer search, a search condition setting button 320 for setting search conditions, a search result storing button 330 for storing a search results, a search result reading button 340 for reading the search results, a search result display area 350 for displaying a list of the printer search results, an OK button 301 for applying a printer selected on the search result display area 350 to a printer that executes printing (a port that outputs print data), and a cancel button 302 for cancelling the application.

When the selection of the search execution button 310 is received, the setting reception section 120 requests to the printer search section 130 for the process of searching for printers that the host computer 1 can use. In addition, the setting reception section 120 sends the search conditions set on the search condition setting screen 400 in response to the request of the printer search section 130. Furthermore, the search may be automatically performed when the printer selection screen 300 is displayed.

In the case where the process of searching for printers by the printer search section 130 is completed, the setting reception section 120 acquires the search results stored in the printer information storage section 140 and displays the result in the search result display area 350.

The search results are constituted by, for example, a list of entries corresponding to information indicating the model names of printers, ports, printable paper sizes, printable colors (color/black), support of double-sided printing, and type of connection with the host computer 1 (network). Of course, the constitution of the search results is not limited thereto, and for example, it may include information indicating status of printers (printing, idling, the amount of toner, or the like).

The setting reception section 120 receives selection of any one entry by a user's operation from the list of printers displayed in the search result display area 350 as above. The selection of the entry is implemented, for example, by movement of the cursor (shaded portion in the drawing).

When the selection of the OK button 301 is received, the setting reception section 120 specifies the printer corresponding to the entry selected in the search result display area 350 as a printer that executes printing (a port that outputs print data). Then, the setting reception section 120 instructs the print data generation section 150 to transmit the print data to the specified printer. In addition, the setting reception section 120 closes the printer selection screen 300.

Furthermore, in the search result using method designation area 440 (FIG. 4), when “list all” is designated, the setting reception section 120 displays all of the search results in the search result display area 350. On the other hand, when “select the printer found first” is designated, the setting reception section 120 displays one entry recorded in the printer information storage section 140 in the search result display area 350. In addition, in that case, the printer selection screen 300 may be closed with the selection of a printer corresponding to the entry, without displaying the entry.

When the selection of the search condition setting button 320 is received, the setting reception section 120 displays the search condition setting screen 400 to receive setting for various search conditions.

As shown in FIG. 4, the search condition setting screen 400 includes a printer function designation area 410 that includes an area for designating various printer functions (color printing, printing on A3-size sheets, and double-sided printing in the example of the drawing), a history designation area 420 for setting printers included in the history of the search results as a search range, a history list designation area 421 for selecting a history list, which is the search range, to be described later, a search range designation area 430 for designating the same network segment as the host computer 1 (the range not passing beyond a router) as the printer search range, a search result using method designation area 440 for designating the treatment of the search results (whether all the results are to be listed or not, or whether the printer found first is to be automatically selected as the output destination port or not in the example of the drawing), and a close button 401 for closing the search condition setting screen 400. In the example of the drawing, the history list designation area 421 is realized by a drop-down list which allows a user to select an entry of the history list from the list displayed by clicking operation.

The setting reception section 120 stores various search conditions set in the search condition setting screen 400 in, for example, the RAM 11 or the auxiliary storage device 13.

When the selection of the search result storing button 330 is received, the setting reception section 120 displays the search result storing screen 500 and receives the setting for storing the search results.

As shown in FIG. 5, the search result storing screen 500 includes an available printer display area 510 in which a list of the search results are displayed in the same manner as the one displayed in the search result display area 350 (FIG. 3), a history list designation area 520 for selecting one of the plural entries in the history list, a history list display area 521 in which the history list selected in the history list designation area 520 is displayed, a deletion designation area 522 in which an entry to be deleted is designated from the displayed history list, an upward movement button 523 for raising the ranking of the entry selected from the history list, a downward movement button 524 for lowering the ranking of the entry selected from the history list, a refresh button 525 for deleting the entry designated in the deletion designation area 522, an entry addition button 530 that adds the entry selected from the list displayed in the available printer display area 510 to the history list displayed in the history list display area 521, and a close button 501 for closing the search result storing screen 500. In the example of the drawing, the history list designation area 520 is realized by a drop-down list which allows a user to select a history list from the lists displayed by clicking operation.

The setting reception section 120 displays, in the available printer display area 510, a list of the search results in the same manner as the one displayed in the search result display area 350 (FIG. 3). In addition, the setting reception section 120 acquires the history list selected in the history list designation area 520 from the printer information storage section 140 and displays the list in the history list display area 521.

Similar to the search results, the history list is constituted by a list of entries corresponding to information indicating, for example, model names of printers, ports, printable paper sizes, printable colors (color/black), support of double-sided printing, and type of connection with the host computer 1 (network). Of course, the constitution of the history list is not limited thereto, and for example, it may include information indicating printer use frequency (the number of times, or the like). In addition, each history list is stored in the printer information storage section 140 in association with identification information (an arbitrary title “the fifth floor of the seventh building” in the example of the drawing).

Furthermore, the setting reception section 120 displays the identification information of each history list in the history list designation area 421 (FIG. 4), the history list designation area 520 (FIG. 5), and a history list designation area 620 (FIG. 6). Moreover, a new list (or an empty list) can be selected in the history list designation area 520. In this case, identification information may be input into the history list designation area 520. When a new list is selected, the corresponding list is added and stored into the printer information storage section 140.

The setting reception section 120 receives the selection of an entry from the list of printers displayed in the available printer display area 510 as described above by a user's operation. The selection of the entry is implemented by the movement of the cursor (the shaded portion in the drawing).

When the selection of the entry addition button 530 is received, the setting reception section 120 adds the entry selected in the available printer display area 510 to a predetermined ranking (for example, the top ranking, the lowest ranking, or the upper or the lower row of the cursor) of the history list displayed in the history list display area 521. In addition, at the same time as that operation, the history list recorded in the printer information storage section 140 is refreshed.

When the upward movement button 523 is selected, the setting reception section 120 raises the ranking of the entry selected in the history list display area 521 by one. When the downward movement button 524 is selected, the setting reception section 120 lowers the ranking of the entry selected in the history list display area 521 by one. In addition, at the same time of that operation, the history list recorded in the printer information storage section 140 is refreshed.

When the refresh button 525 is selected, the setting reception section 120 deletes the entry designated in the deletion designation area 522 from the history list displayed in the history list display area 521. In addition, at the same time of that operation, the history list recorded in the printer information storage section 140 is refreshed.

When the selection of the search result reading button 340 is received, the setting reception section 120 displays the search result reading screen 600 and receives the setting for reading the search results.

As shown in FIG. 6, the search result reading screen 600 includes a history list designation area 620 for selecting one entry from plural entries on the history list, a history list display area 621 that displays the history list selected in the history list designation area 620, a reading button 625 that displays, in the search result display area 350 (FIG. 3), the history list displayed in the history list display area 621, and a close button 601 for closing the search result reading screen 600. In the example of the drawing, the history list designation area 620 is realized by a drop-down list which allows a user to select a history list from the list displayed by clicking operation.

The setting reception section 120 acquires the history list selected in the history list designation area 620 from the printer information storage section 140 and displays the list in the history list display area 621. In addition, when the selection of the reading button 625 is received, the setting reception section 120 displays the history list displayed in the history list display area 621 in the search result display area 350 (FIG. 3).

Furthermore, the selection of one entry or plural entries from the history list displayed in the history list display area 621 may be received as described above by a user's operation and the selected entry (or entries) may be read.

The composition, display mode, control method of various UI screens or the like shown above are exemplified in order to easily understand the composition of the printer driver unit 110. The invention is not limited to the composition, display mode, control method of various UI screens shown above. For example, all of the various screens can be displayed in one screen. In addition, for example, all of the various screens can be displayed by being divided into more screens.

Returning to FIG. 2, the printer search section 130 searches for one of the printers 2 available by the host computer 1 from among the printers 2 connected to the network. In addition, the printer search section 130 acquires printer information from each of the printers, creates a list of printers based on the information, and stores the list as search results in the printer information storage section 140.

The printer information is, for example, for identifying the printers 2 connected to the network (IP address, MAC address, product model name, or the like), for indicating functions of the printers 2 (the number of feeding devices, the size of sheets being fed, the presence of a double-sided printing mechanism, or the like), for indicating the status of the printers 2 (idling, printing, the amount of toner, or the like), or the like.

During the search process, the printer search section 130 acquires search conditions set in the search condition setting screen 400 (FIG. 4) from the setting reception section 120. Then, the printer search section 130 carries out the search process based on the search conditions.

For example, when “double-sided printing” is designated in the printer function designation area 410, the printer search section 130 does not add printers that cannot carry out double-sided printing to the list of the search results.

In addition, when a specific history list is designated in the history list designation area 421, or when a specific history list is read in the search result reading screen 600, the printer search section 130 searches for the printer 2 that meets the various search conditions and is available from the designated or read history list, without searching for new printers on the network. At that time, it is not necessary to acquire printer information again, but at least whether each printer is available or not is determined, and the result is included in the search results (The setting reception section 120 displays each entry on the list displayed in the search result display area 350 in association with the information whether the corresponding printer is available or not). Moreover, the setting of either the history list designation area 421 or in the search result reading screen 600 may be given priority.

Furthermore, when the search range designation area 430 is selected, the printer search section 130 searches for printers in the same segment as the host computer 1 (in the range not exceeding the router).

Furthermore, when “list all” is designated in the search result using method designation area 440, the printer search section 130 records all printers to be search target as the search results. On the other hand, when “select the printer found first” is designated, the printer search section 130 completes the searching process at the time when one printer is found and records the printer as the search results.

Moreover, when a specific history list is designated or read, the printer search section 130 performs search in a predefined order of entries recorded in the corresponding list (from top to the bottom in the embodiment shown in the drawing).

The printer information storage section 140 stores the list of the search results or the history list described above in, for example, the RAM 11 or the auxiliary storage device 13. In addition, the printer information storage section 140 reads the search results or the history list according to requests from other functioning sections.

The print data generation section 150 generates print data based on the print setting sent from the setting reception section 120 and the print target data designated in the application unit 100. In addition, the print data generation section 150 transmits the generated print data to the printer 2 selected in the setting reception section 120.

Specifically, print instruction is received from the setting reception section 120 and print settings (for example, print setting applied in a predetermined UI screen of the setting reception section 120 and print setting designated in the application unit 100 are included) are acquired from the setting reception section 120. In addition, the print target data designated in the application unit 100 are acquired from the setting reception section 120. Then, such acquired data are transformed into print data based on the print settings. Then, the data are transmitted to the printer selected in the printer selection screen 300.

Respective constituent elements described above are classified according to major contents of the processes in order to easily understand the composition of the host computer 1. The invention is not limited to the classifying method or titles of the constituent elements. The composition of the host computer 1 can be classified into further constituent elements according to the contents of the processes. In addition, one constituent element can be classified so that the element carries out even more processes. Moreover, the processes of the respective constituent elements may be realized by one piece of hardware, or by plural pieces of hardware.

Next, a characteristic process realized by the above host computer 1 will be described.

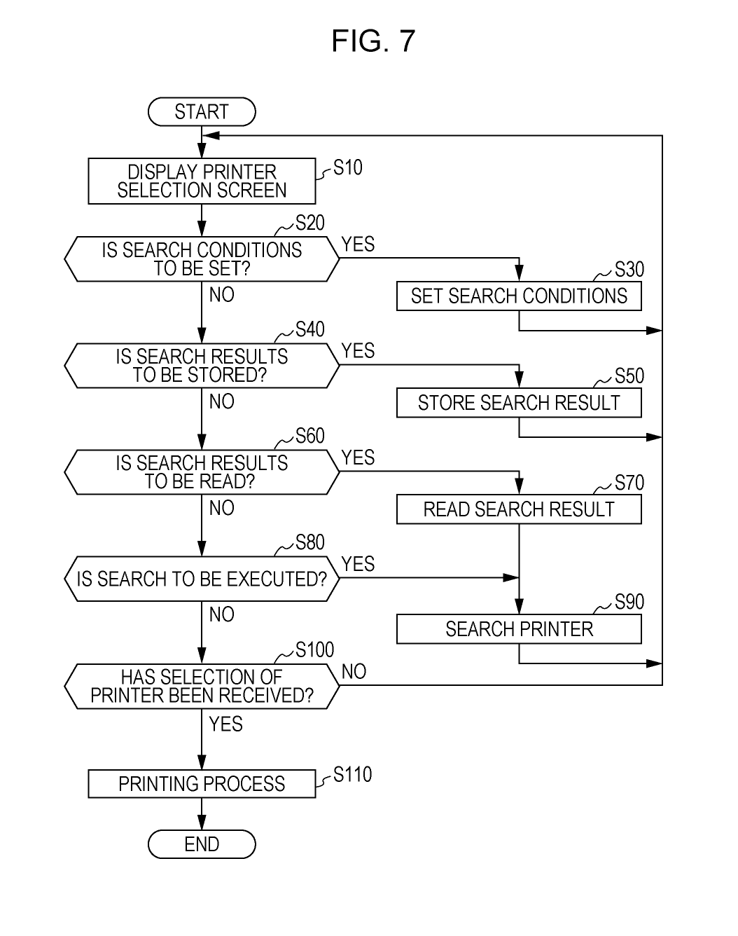

FIG. 7 is a flowchart illustrating an example of a printer selecting process. The flow starts, for example, when the printer driver unit 110 receives designation of the print setting or instruction of print start from the application unit 100. The designation of the print setting or the instruction of the print start is activated via the UI screen for printing of the application unit 100 or the like.

In S10, the setting reception section 120 displays the printer selection screen 300. Specifically, the setting reception section 120 displays the search result display area 350 in an empty state immediately after the start of this flow. When printer search is executed in S90, the setting reception section 120 acquires the search results from the printer information storage section 140 and displays in the search result display area 350. Then, the process advances to S20.

In S20, the setting reception section 120 determines whether setting for search conditions has been instructed or not. Specifically, the setting reception section 120 determines whether the search condition setting button 320 has been selected or not. When the search condition setting button 320 has been selected (S20:YES), the process advances to S30. When the search condition setting button 320 has not been selected (S20:NO), the process advances to S40.

In S30, the setting reception section 120 receives the setting for search conditions. Specifically, the setting reception section 120 displays the search condition setting screen 400 and receives changes of the various search conditions. In addition, the setting reception section 120 stores the various search conditions set in the search condition setting screen 400. Thereafter, the setting reception section 120 receives the selection of the close button 401 to close the search condition setting screen 400, and the process returns to S10.

In S40, the setting reception section 120 determines whether it is instructed to store the search results or not. Specifically, the setting reception section 120 determines whether the search result storing button 330 has been selected or not. When the search result storing button 330 has been selected (S40:YES), the process advances to S50. When the search result storing button 330 has not been selected (S40:NO), the process advances to S60.

In S50, the setting reception section 120 stores the search results. Specifically, the setting reception section 120 displays the search result storing screen 500 and receives the setting for storing the search results. In addition, setting reception section 120 stores the list displayed in the history list display area 521 in the printer information storage section 140 as required. Thereafter, the setting reception section 120 receives the selection of the close button 501 to close the search result storing screen 500 and the process returns to S10.

In S60, the setting reception section 120 determines whether or not it is instructed to read the search results. Specifically, the setting reception section 120 determines whether the search result reading button 340 has been selected or not. When the search result reading button 340 has been selected (S60:YES), the process advances to S70. When the search result reading button 340 has not been selected (S60:NO), the process advances to S80.

In S70, the setting reception section 120 reads the search results. Specifically, the setting reception section 120 displays the search result reading screen 600 and receives the setting for reading the search results. Then, the setting reception section 120 closes the search result reading screen 600 after receiving the selection of the close button 601 and the process advances to S90.

In S80, the setting reception section 120 determines whether or not it is instructed to execute a search. Specifically, the setting reception section 120 determines whether the search execution button 310 has been selected or not. When the search execution button 310 has been selected (S80:YES), the process advances to S90. When the search execution button 310 has not been selected (S80:NO), the process advances to 5100.

In S90, the printer search section 130 executes the process of searching printers. Specifically, the printer search section 130 acquires the search conditions set in the search condition setting screen 400 from the setting reception section 120, and searches for an available printer based on the search conditions. When the search results are read in S70, an available printer is searched for from the read list based on the search conditions. Furthermore, when the search results are read, for example, an available printer may be searched from the read list regardless of the presence of the selection of the history designation area 420. In addition, the printer search section 130 stores the search results in the printer information storage section 140. Then, the process returns to S10.

In S100, the setting reception section 120 determines whether the selection of the printer has been received or not. Specifically, the setting reception section 120 receives the selection from the list of printers displayed in the search result display area 350. In addition, the setting reception section 120 determines whether the OK button 301 has been selected or not. When the OK button 301 has been selected (S100:YES), the process advances to S110. When the OK button 301 has not been selected (S100:NO), the process returns to S10.

In S110, the print data generation section 150 executes the printing process. Specifically, for example, when this flow is started by the instruction of print setting, the printing process starts after the application unit 100 gives the setting reception section 120 the instruction of print start. On the other hand, when this flow is started by the instruction of the print start, the printing process starts without waiting for the instruction of print start from the application unit 100. Then, the print data generation section 150 generates the print data based on the print setting sent from the setting reception section 120 and the print target data designated by the application unit 100. In addition, the print data are transmitted to the printer 2 selected in S100. Then, the flow ends.

The description of the flow shown above is to describe the flow of major processes in the regard to the characteristics of the invention, and other processes are not excluded therefrom. In addition, processing units in the flow above are divided according to the major contents of the processes in order to easily understand the processes of the host computer 1. The invention is not limited to the dividing method or the title of the processing units. The processes of the host computer 1 can be divided into even more processing units according to the contents of the processes. In addition, the processes can be divided so that one processing unit includes further processes.

Hereinabove, one embodiment of the invention is described. According to the embodiment, it is possible to enhance efficiency in a printer search and convenience for a user.

In other words, according to the embodiment, it is possible to store the printers which were available in the past as a history and to designate the history as a search range. In addition, it is possible to designate further detailed search conditions. Moreover, users can make such setting. Since the printers to be searched for are narrowed down by the search range and conditions that the users desire in such a configuration, search efficiency and convenience are improved.

Furthermore, such search efficiency and convenience are improved further by a configuration in which a list is created by changing the rankings of printers upon storing search results, or a configuration in which a printer that was determined to be available first is selected.

For example, if a list is created for every LAN in an office where a user frequently visits and the printers that were used are registered, an output destination port can be decided in a shorter time and printing can be executed by an optimal printer that the user wants to use.

Furthermore, the above embodiment of the invention intends to exemplify the gist and the range of the invention, but is not limited thereto. Many substitutes, alterations and modified examples are clear to a person skilled in the art.

Furthermore, the invention can be applied not only to printers but also to a printing system including printing devices that have the function of a printer such as copy machines, multifunction peripherals, and the like.

What is claimed is:

1. A computer readable recording medium recording a printer driver in which the printer driver makes a computer function as a device comprising:
a search unit which searches for printers that can be used for printing; and
a printer information storage unit which stores predetermined information relating to at least some of the printers out of the searched printers,
wherein the search unit executes searches having the printers of which the predetermined information is stored as a search range.

2. The computer readable recording medium recording the printer driver according to claim 1, in which the printer driver makes the computer function as a device further comprising:
a first reception unit which displays a list of the searched printers and receives a selection of at least some of the printers from the list,
wherein the printer information storage unit stores the predetermined information of the selected printers.

3. The computer readable recording medium recording the printer driver according to claim 2, in which the printer driver makes the computer function as a device further comprising:
a second reception unit which receives selection of a history list which is a search range, wherein
the first reception unit receives selection of the history list on which the selected printers are recorded;
the printer information storage unit can store a plurality of history lists and stores the predetermined information of the selected printers on the selected history list; and
the search unit executes searches having the history list selected by the second reception unit as a search range.

4. The computer readable recording medium recording the printer driver according to claim 3, wherein
the first reception unit receives identification information of the history lists;
the printer information storage unit stores the plurality of the history lists in association with the identification information; and
the second reception unit receives selection of a history list based on the identification information.

5. The computer readable recording medium recording the printer driver according to claim 3, wherein
the first reception unit receives input of rank order information of the printers recorded on the history list; and
the printer information storage unit stores the predetermined information of the selected printers in association with the rank order information.

6. The computer readable recording medium recording the printer driver according to claim 5, wherein
the search unit determines the printer which was found first according to the rank order information as a printer which can be used for printing having the selected history list as a search range.

7. A print control device which searches for printers, comprising:
a search unit which searches for printers which can be used for printing; and
a printer information storage unit which stores predetermined information relating to at least some of the printers out of the searched printers, wherein
the search unit executes searches having the printers of which the predetermined information is stored as a search range.

8. A computer readable recording medium recording a printer search program in which the printer search program makes a computer function as a device comprising:
a search unit which searches for printers that can be used for printing; and
a printer information storage unit which stores predetermined information relating to at least some of the printers out of the searched printers, wherein
the search unit executes searches having the printers of which the predetermined information is stored as a search range.
